(19) United States
(12) Patent Application Publication
(10) Pub. No.: US 2012/0251102 A1
(43) Pub. Date: Oct. 4, 2012

(54) LIGHT RECEIVING CIRCUIT AND BANDWIDTH CONTROL METHOD

(75) Inventors: Yoshikazu TERAYAMA, Kawasaki (JP); Norifumi Shukunami, Kawasaki (JP); Masahiro Yuki, Kawasaki (JP)

(73) Assignee: FUJITSU LIMITED, Kawasaki-shi (JP)

(21) Appl. No.: 13/429,760

(22) Filed: Mar. 26, 2012

(30) Foreign Application Priority Data
Mar. 31, 2011 (JP) 2011-081138

(51) Int. Cl. H04B 10/08

(52) U.S. Cl. 398/25

(57) ABSTRACT

A light receiving circuit includes: a filter, arranged in a downstream of an electric signal amplifier to amplify an electric signal based on a light signal, to adjust a bandwidth of an amplified electric signal; a monitor circuit to monitor a communication quality of the light signal and output a monitored value; and a control circuit to control a bandwidth of the filter based on a control value corresponding to the monitored value.

### CROSS-REFERENCE TO RELATED APPLICATION

This application is based upon and claims the benefit of priority of the prior Japanese Patent Application No. 2011-81138, filed on Mar. 31, 2011, the entire contents of which are incorporated herein by reference.

### FIELD

The embodiments discussed herein are related to a light receiving circuit and a bandwidth control method.

### BACKGROUND

In the area of optical transmission, in accordance with increases in capacity, speed, and bandwidth of networks, 40 Gbps lines have been introduced. Modulation methods, such as wavelength division multiplexing (WDM) in which high-speed and high-capacity optical transmission is performed with a wide bandwidth, include differential quadrature phase shift keying (DQPSK), differential phase shift keying (DPSK), and the like.

Examples of related art are disclosed, for example, in Japanese Laid-open Patent Publication Nos. 2008-278249, 2005-204019, and 2009-5110.

### SUMMARY

According to one aspect of the embodiments, a light receiving circuit includes: a filter, arranged in a downstream of an electric signal amplifier to amplify an electric signal based on a light signal, to adjust a bandwidth of an amplified electric signal; a monitor circuit to monitor a communication quality of the light signal and output a monitored value; and a control circuit to control a bandwidth of the filter based on a control value corresponding to the monitored value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary light receiving circuit;

FIG. 2 illustrates an exemplary light receiving circuit;

FIG. 3 illustrates an exemplary information;

FIGS. 4A to 4R illustrate exemplary electric spectrum characteristics;

FIGS. 5A to 5R illustrate exemplary electric waveform characteristics;

FIG. 6 illustrates an exemplary relationship between a DGD value and a Q value;

FIG. 7 illustrates an exemplary filter;

FIG. 8 illustrates an exemplary bandwidth control process;

FIG. 9 illustrates an exemplary light receiving circuit;

FIG. 10 illustrates an exemplary bandwidth control process;

FIG. 11 illustrates an exemplary light receiving circuit; and

FIG. 12 illustrates an exemplary light receiving circuit.

### DESCRIPTION OF EMBODIMENTS

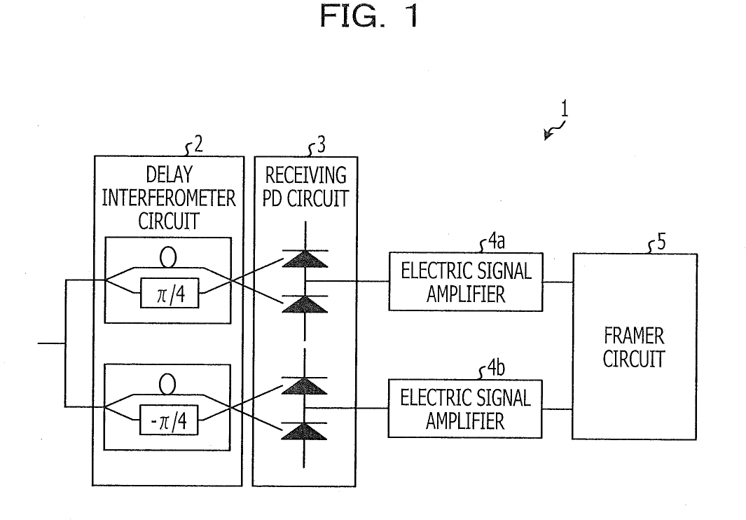

FIG. 1 illustrates an exemplary light receiving circuit. A light receiving circuit 1 includes, in a DQPSK modulation method, a delay interferometer circuit 2, a receiving photodiode (PD) circuit 3, an electric signal amplifier 4a, an electric signal amplifier 4b, and a framer circuit 5.

The delay interferometer circuit 2 demodulates an input light signal of phase-modulated input light. For example, individual circuits provided in the delay interferometer circuit 2 detect an input light signal, which has been input at a rate of 40 Gbps, as an input light signal at a rate equivalent to 20 Gbps. In an upper circuit in the delay interferometer circuit 2, a delay time equivalent to 1 bit is assigned to an input light signal that has been branched into two. In a lower circuit in the delay interferometer circuit 2, an input light signal that has been branched into two is phase-shifted by π/4. In the delay interferometer circuit 2, due to interference between the input light signal to which a delay time is assigned and the input light signal that is phase-shifted, demodulation of the input light signals is performed.

The receiving PD circuit 3 converts the input light signals, which have been demodulated by the delay interferometer circuit 2, into electric signals. For example, the receiving PD circuit 3 converts the demodulated input light signals, which are output from the individual circuits in the delay interferometer circuit 2, into electric signals. The electric signal amplifiers 4a and 4b each amplify the electric signal converted by the receiving PD circuit 3. For example, the electric signal amplifiers 4a and 4b amplify the electric signals output from corresponding PDs (twin PDs) provided in the receiving PD circuit 3. The electric signals may be output from the electric signal amplifiers 4a and 4b, for example, at a rate of 20 Gbps or more.

The framer circuit 5 acquires frame synchronization from the electric signals amplified by the electric signal amplifiers 4a and 4b, and performs a certain process on the electric signals in units of frames. For example, the framer circuit 5 includes a forward error correction (FEC) decoder. A data error in a frame is detected from an amplified electric signal at a rate of 20 Gbps or more, corrected and is output at a rate of 40 Gbps.

The characteristics of an electric signal with respect to input light may be deteriorated. Since the gain of the amplifiers is adjusted while priority is given to increasing of the gain, the bandwidth of the electric signal may not be properly set. A threshold relating to correction in the FEC decoder arranged in the downstream of the amplifiers is adjusted. Since the threshold changes in accordance with the state of an input light signal, appropriate adjustment may not be performed. Thus, the bandwidth of the electric signal may not be properly set.

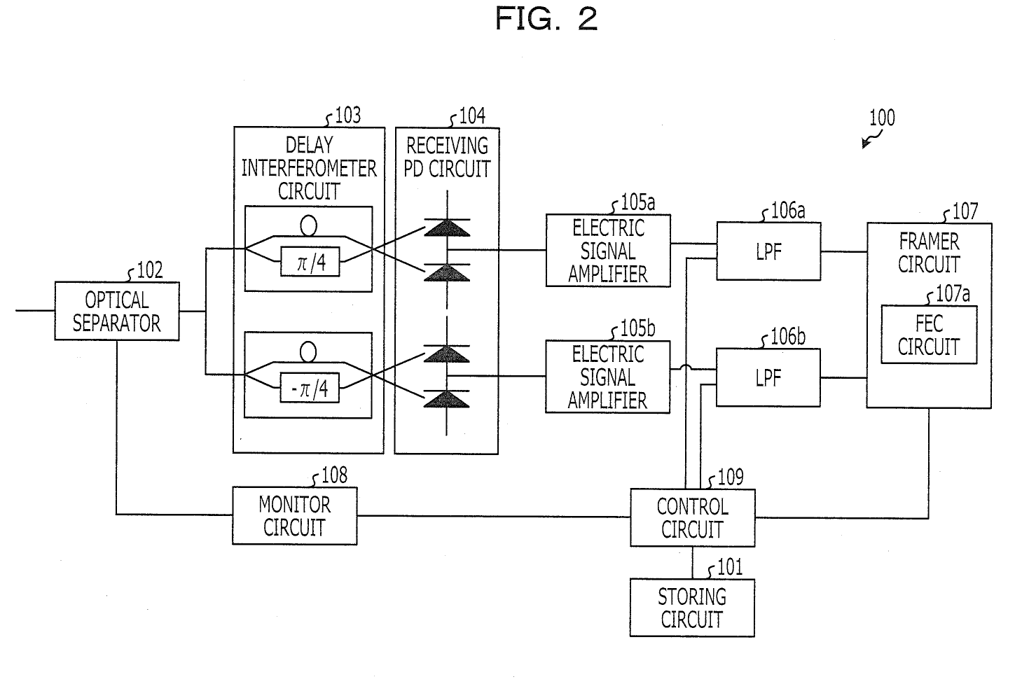

FIG. 2 illustrates an exemplary light receiving circuit. The light receiving circuit illustrated in FIG. 2 may adopt the DQPSK modulation method.

A light receiving circuit 100 includes a storing circuit 101, an optical separator 102, a delay interferometer circuit 103, a receiving PD circuit 104, an electric signal amplifier 105a, and an electric signal amplifier 105b. The light receiving circuit 100 also includes a low pass filter (LPF) 106a, an LPF 106b, a framer circuit 107, a monitor circuit 108, and a control circuit 109.

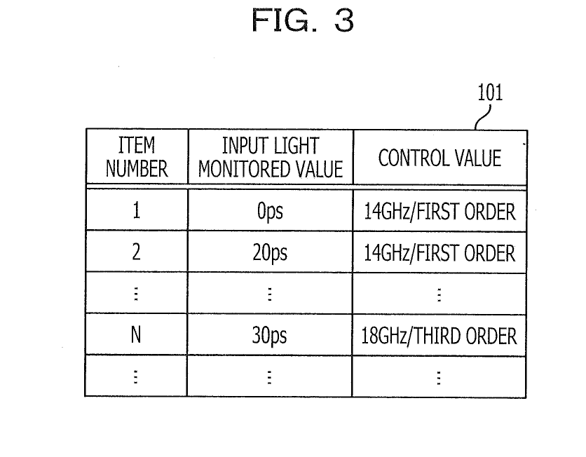

For example, the storing circuit 101 stores a monitored value of an input light signal and a control value for the bandwidth of the LPF 106a or 106b corresponding to the monitored value, in association with each other. FIG. 3 illustrates an exemplary information. The information illustrated in FIG. 3 may be stored in the storing circuit 101. For example, the storing circuit 101 stores an input light monitored value and a control value in association with each other. For example, the storing circuit 101 stores an item number “1”, an input light monitored value “0 pico second (ps)”, and a control value “14 GHz/first order” in association with each other. For example, the storing circuit 101 stores, an item number “2”, an input light monitored value “20 ps”, and a control value “14 GHz/first order” in association with each other. For example, the storing circuit 101 stores an item number “N” (N represents a natural number), an input light monitored value “30 ps”, and a control value “18 GHz/third order” in association with each other. The “first order”, the “third order”, or the like represents a Gaussian order included in the filter slope characteristics of the LPFs 106a and 106b.

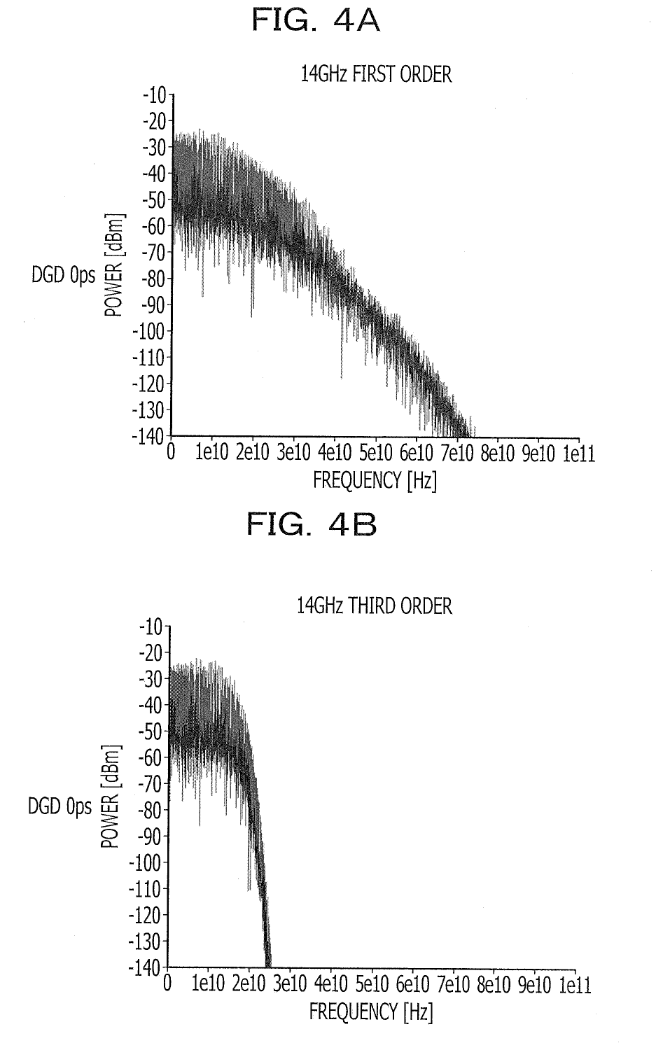

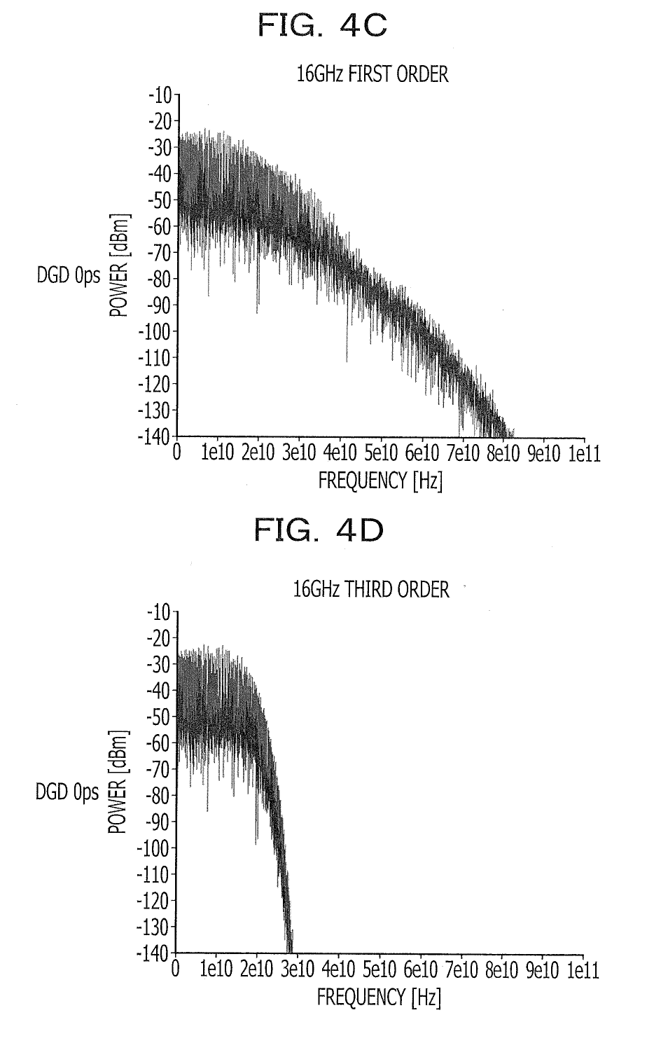

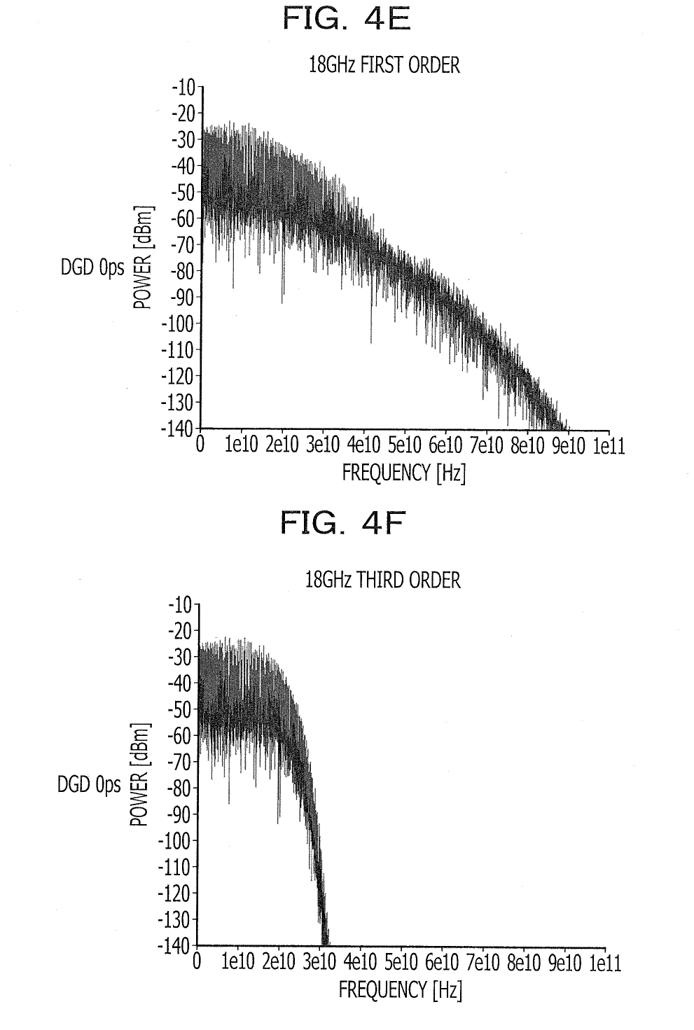

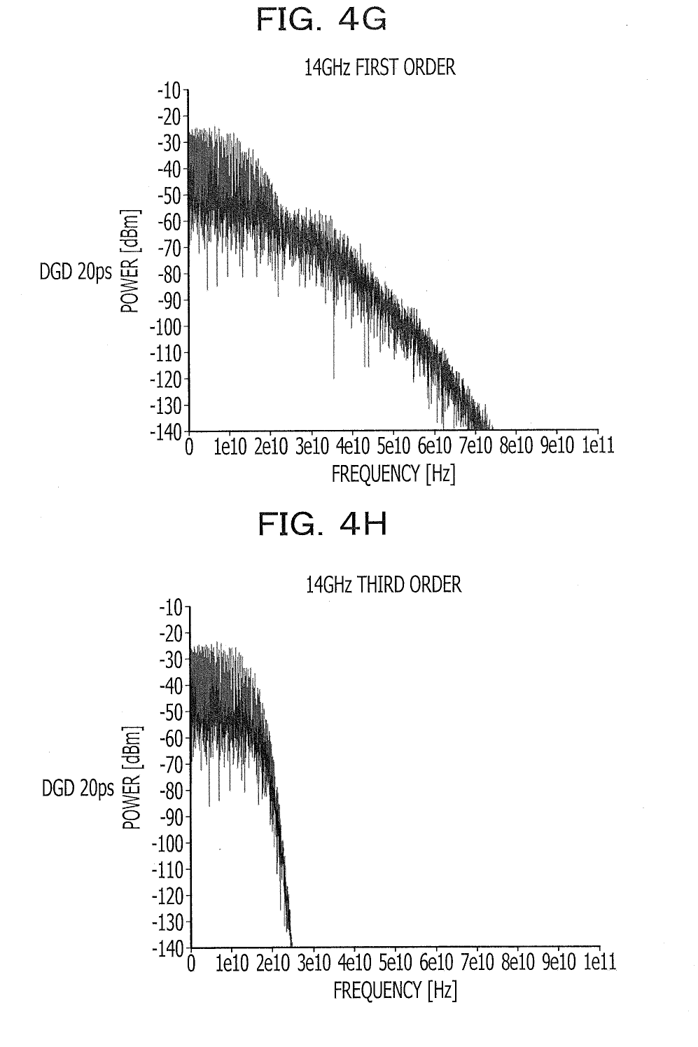

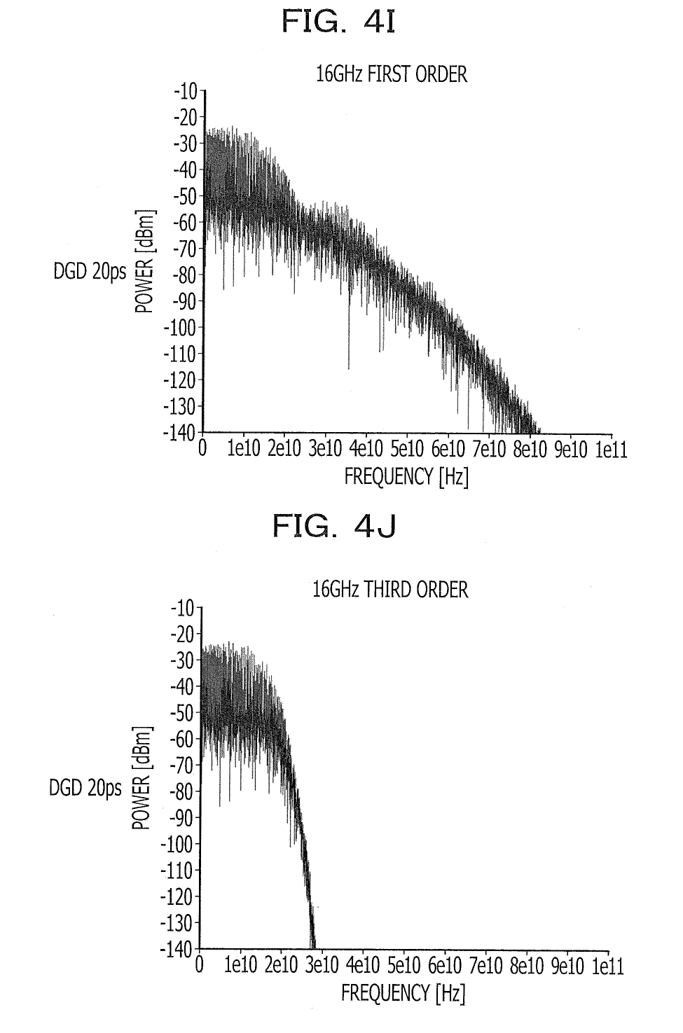

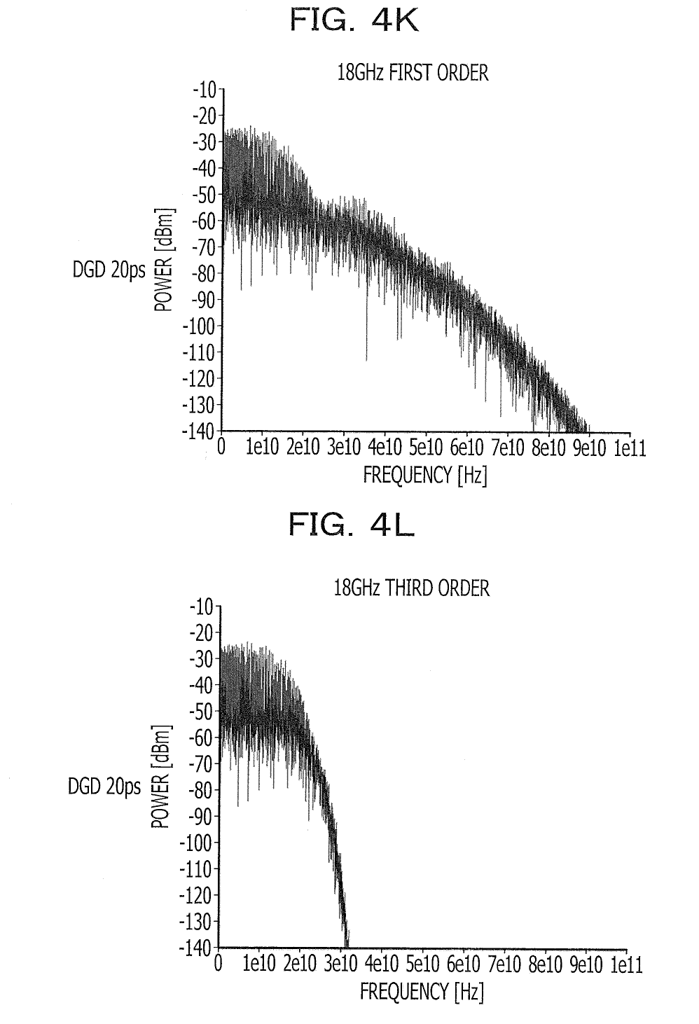

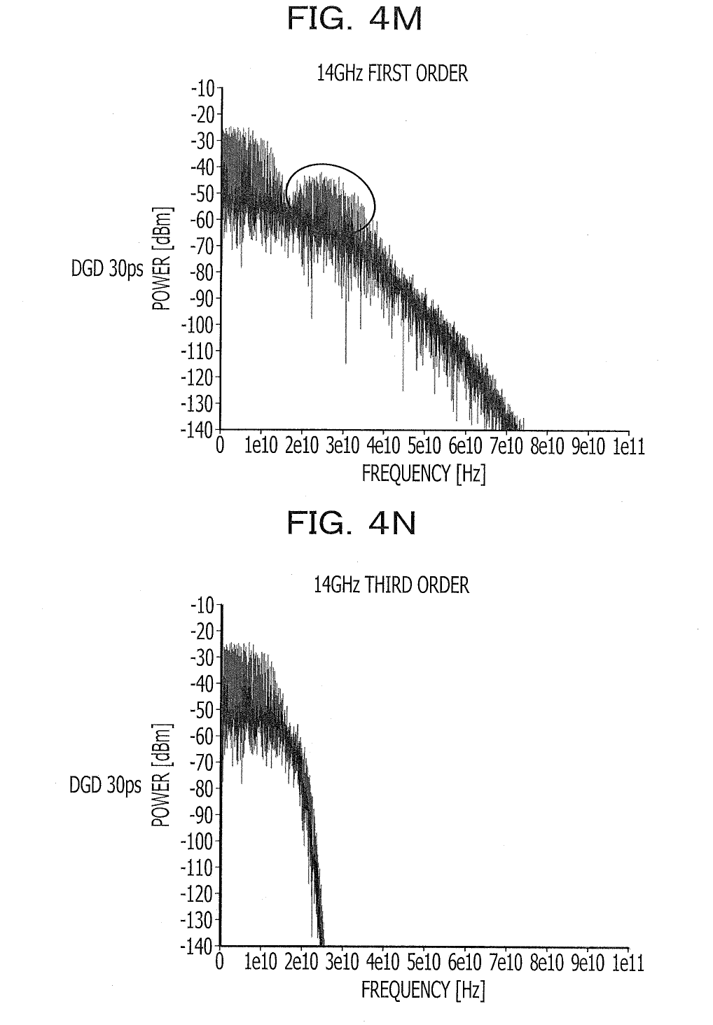

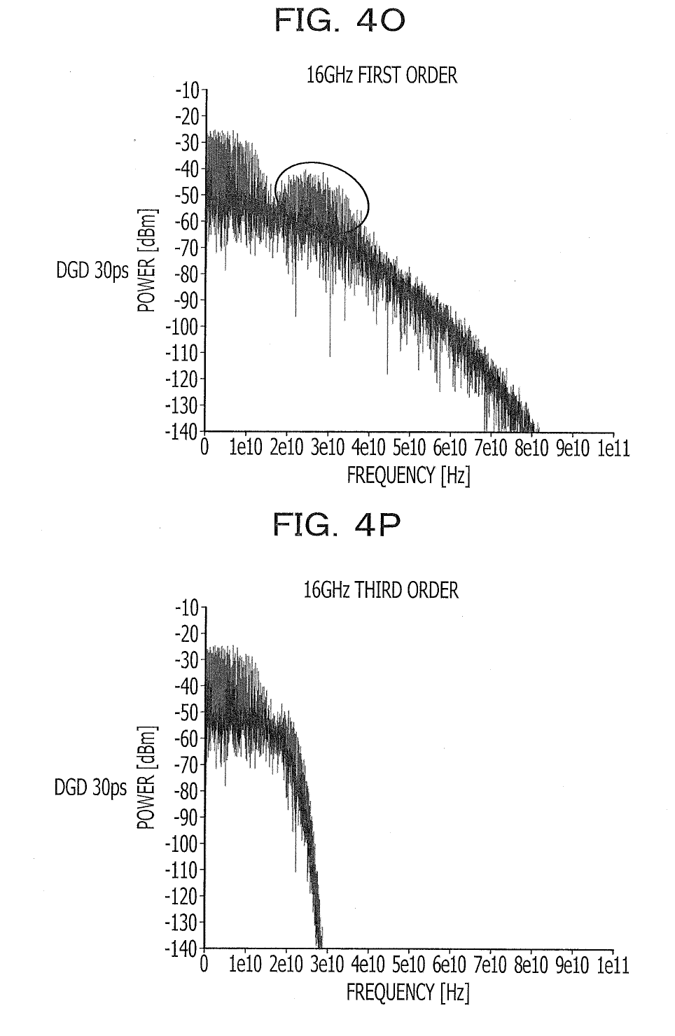

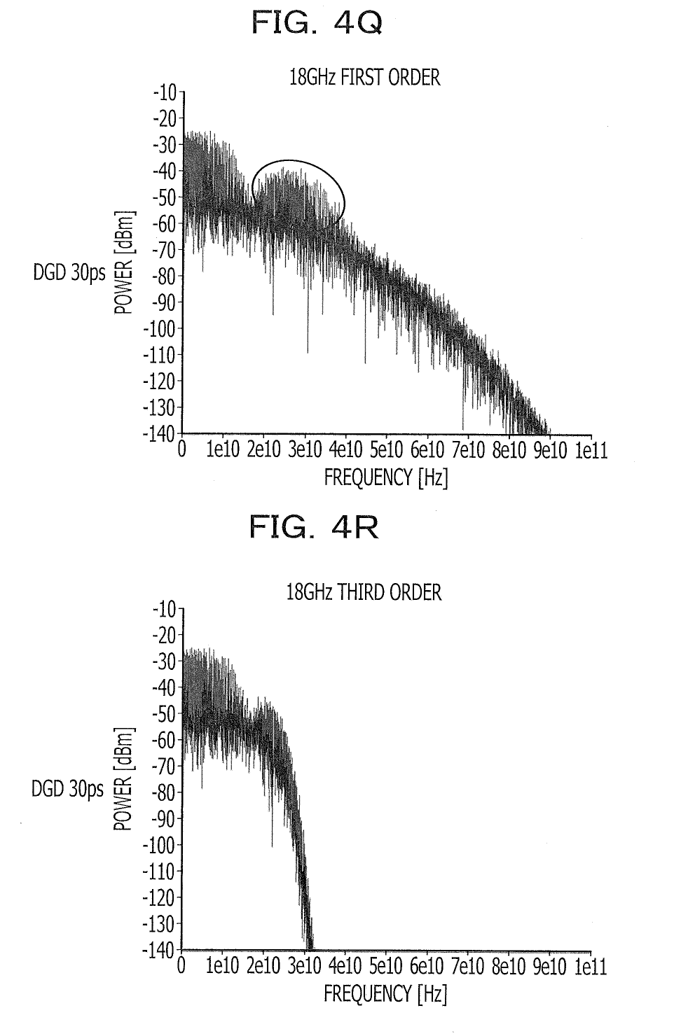

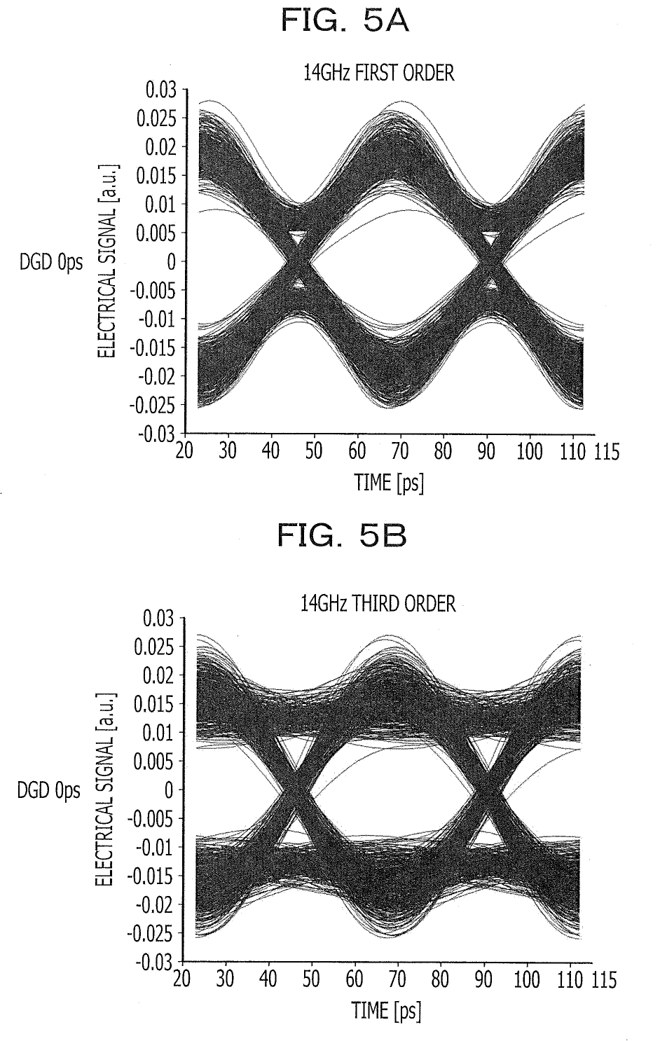

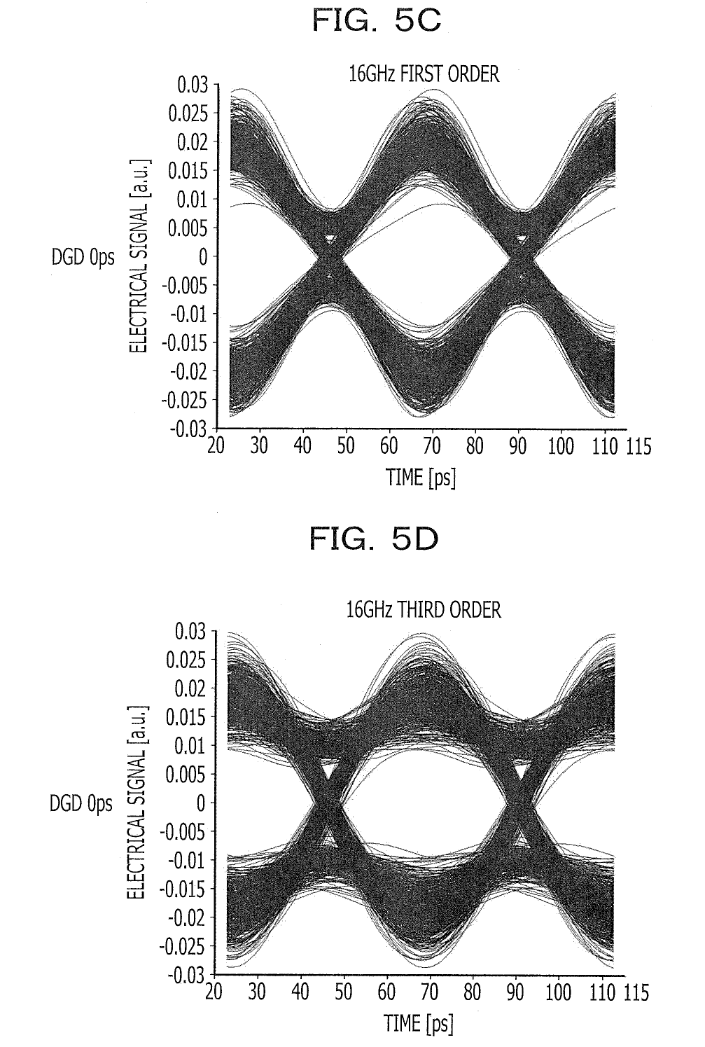

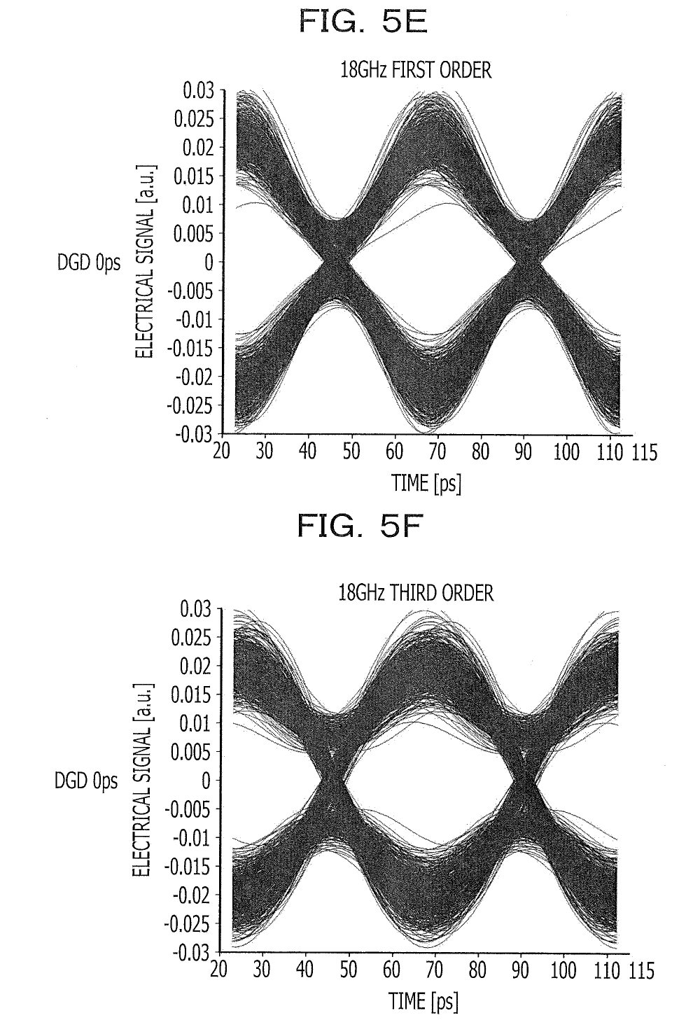

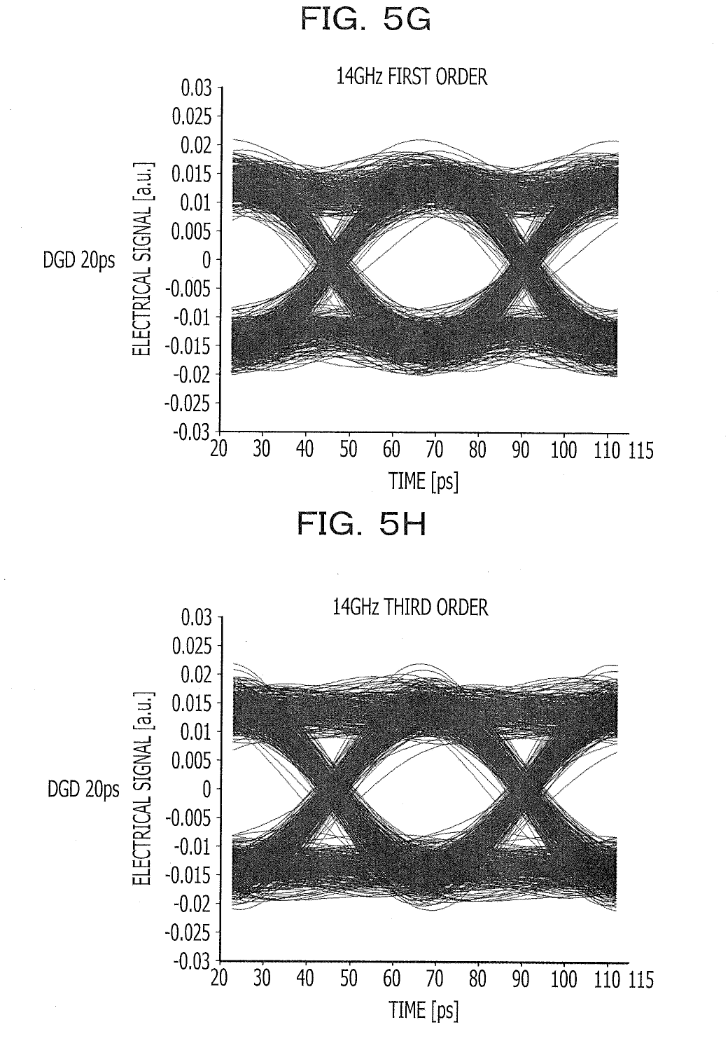

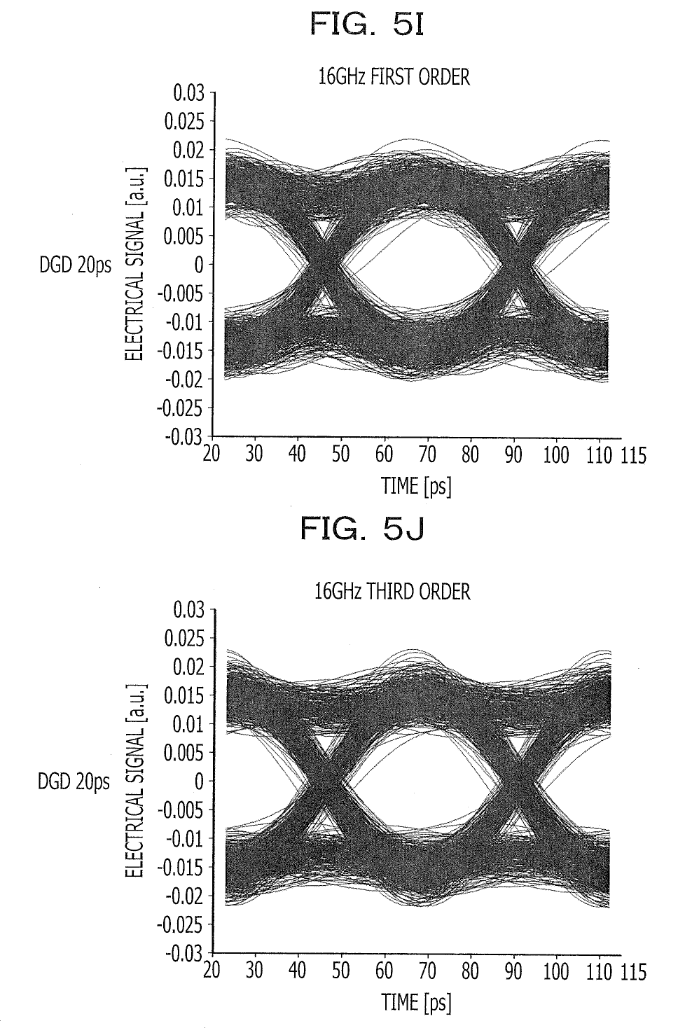

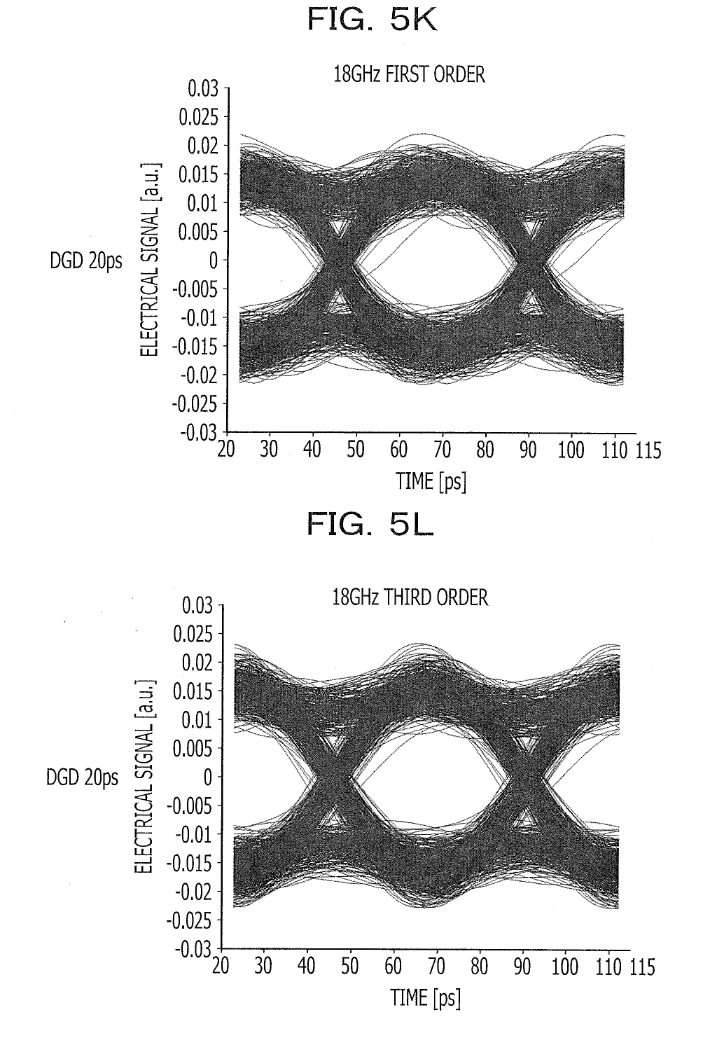

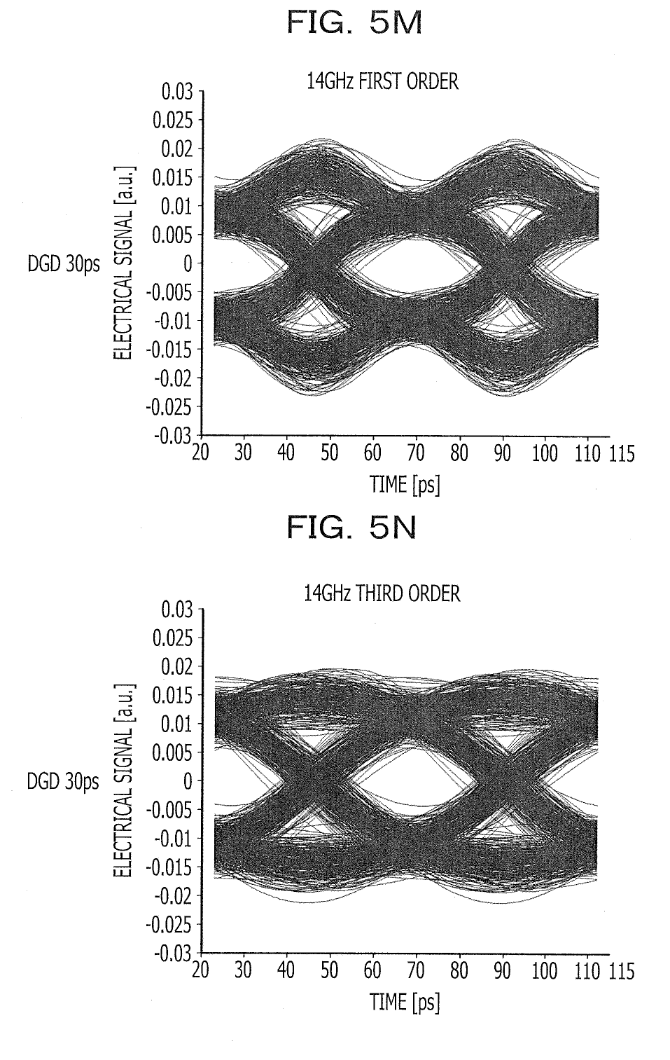

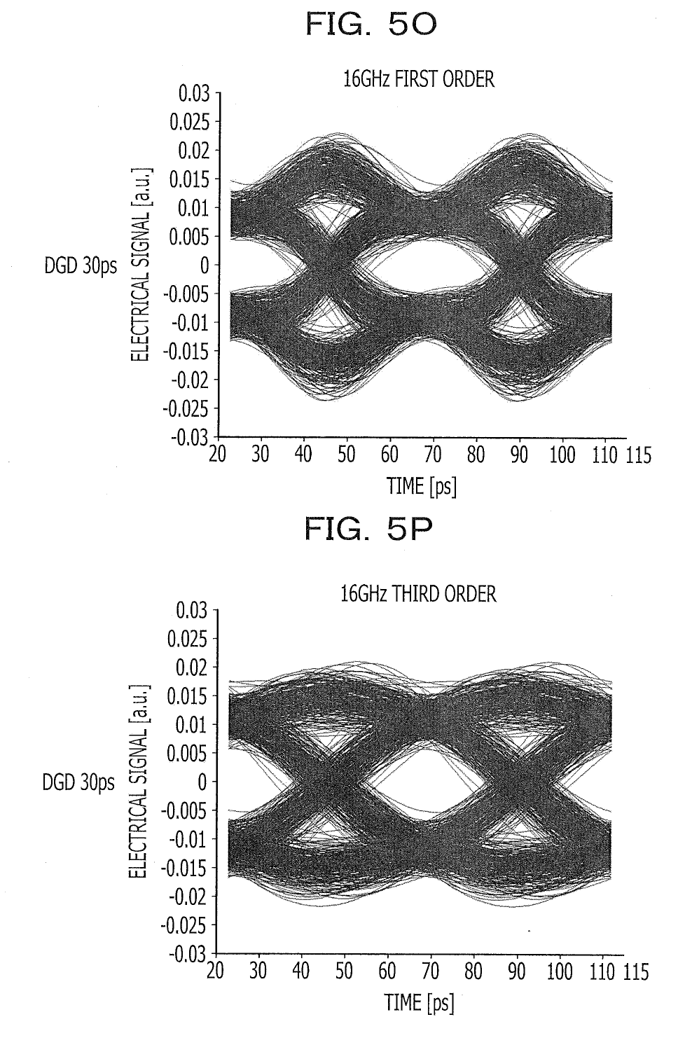

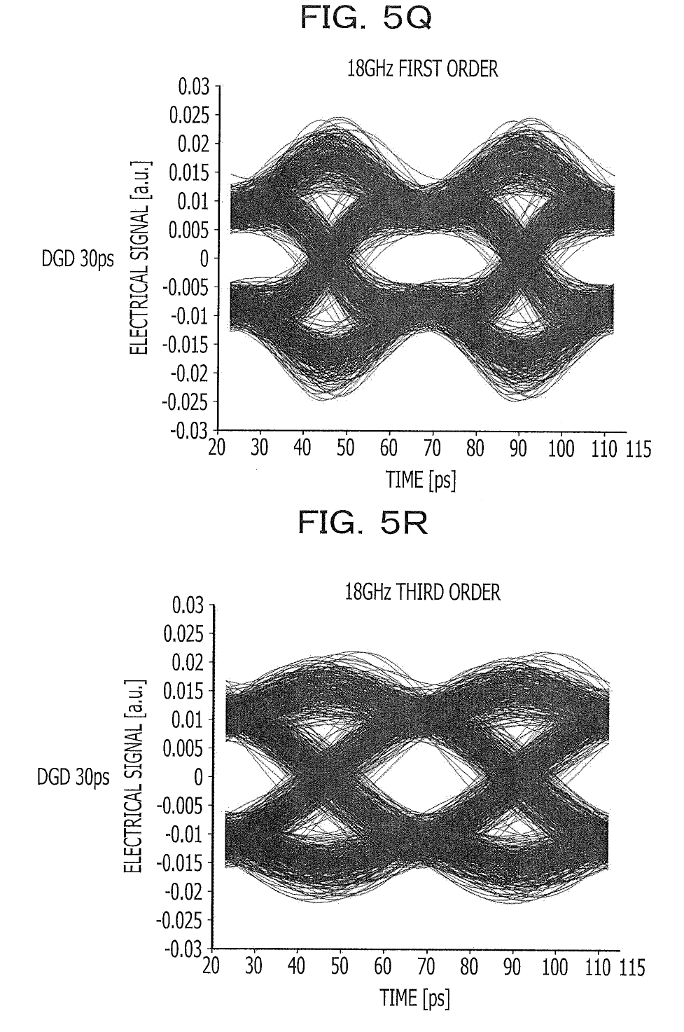

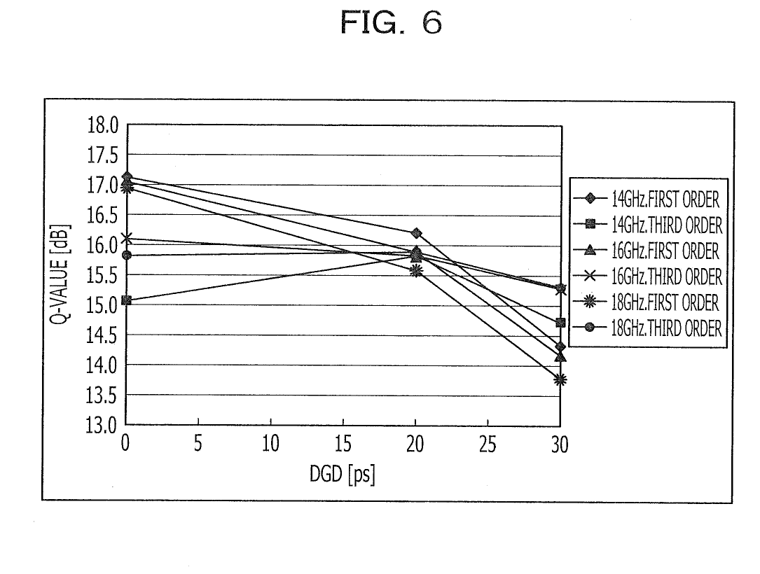

FIGS. 4A to 4R illustrate examples of electric spectrum characteristics. In FIGS. 4A to 4R, the relationship between a state of a differential group delay (DGD) assigned to an input light signal and the spectrum of electric signal characteristics may be illustrated. FIGS. 5A to 5R illustrate exemplary electric waveform characteristics. In FIGS. 5A to 5R, the relationship between the state of a DGD assigned to an input light signal and the electric waveform characteristics may be illustrated. FIG. 6 illustrates an exemplary relationship between a DGD value and a Q value. Due to the correlation between the DGD value and the Q value, the Q value may be calculated from the DGD value and the filter characteristics. For example, the monitor circuit 108 illustrated in FIG. 2 may measure the Q value as an example of the communication quality. The electric spectrum characteristics illustrated in FIGS. 4A to 4R and the electric waveform characteristics illustrated in FIGS. 5A to 5R may be detected, for example, by a spectrum analyzer or the like at the time of output from the LPF 106a or 106b illustrated in FIG. 2.

FIG. 4A illustrates the DGD-electric spectrum characteristics when the DGD is “0 ps” and the bandwidth is “14 GHz/first order”. FIG. 4B illustrates the DGD-electric spectrum characteristics when the DGD is “0 ps” and the bandwidth is “14 GHz/third order”. FIG. 4C illustrates the DGD-electric spectrum characteristics when the DGD is “0 ps” and the bandwidth is “16 GHz/first order”.

FIG. 4D illustrates the DGD-electric spectrum characteristics when the DGD is “0 ps” and the bandwidth is “16 GHz/third order”. FIG. 4E illustrates the DGD-electric spectrum characteristics when the DGD is “0 ps” and the bandwidth is “18 GHz/first order”. FIG. 4F illustrates the DGD-electric spectrum characteristics when the DGD is “0 ps” and the bandwidth is “18 GHz/third order”.

FIG. 4G illustrates the DGD-electric spectrum characteristics when the DGD is “20 ps” and the bandwidth is “14 GHz/first order”. FIG. 4H illustrates the DGD-electric spectrum characteristics when the DGD is “20 ps” and the bandwidth is “14 GHz/third order”. FIG. 4I illustrates the DGD-electric spectrum characteristics when the DGD is “20 ps” and the bandwidth is “16 GHz/first order”. FIG. 4J illustrates the DGD-electric spectrum characteristics when the DGD is “20 ps” and the bandwidth is “16 GHz/third order”. FIG. 4K illustrates the DGD-electric spectrum characteristics when the DGD is “20 ps” and the bandwidth is “18 GHz/first order”. FIG. 4L illustrates the DGD-electric spectrum characteristics when the DGD is “20 ps” and the bandwidth is “18 GHz/third order”.

FIG. 4M illustrates the DGD-electric spectrum characteristics when the DGD is “30 ps” and the bandwidth is “14 GHz/first order”. FIG. 4N illustrates the DGD-electric spectrum characteristics when the DGD is “30 ps” and the bandwidth is “14 GHz/third order”. FIG. 4O illustrates the DGD-electric spectrum characteristics when the DGD is “30 ps” and the bandwidth is “16 GHz/first order”. FIG. 4P illustrates the DGD-electric spectrum characteristics when the DGD is “30 ps” and the bandwidth is “16 GHz/third order”. FIG. 4Q illustrates the DGD-electric spectrum characteristics when the DGD is “30 ps” and the bandwidth is “18 GHz/first order”. FIG. 4R illustrates the DGD-electric spectrum characteristics when the DGD is “30 ps” and the bandwidth is “18 GHz/third order”.

FIG. 5A illustrates the DGD-electric waveform characteristics when the DGD is “0 ps” and the bandwidth is “14 GHz/first order”. FIG. 5B illustrates the DGD-electric waveform characteristics when the DGD is “0 ps” and the bandwidth is “14 GHz/third order”. FIG. 5C illustrates the DGD-electric waveform characteristics when the DGD is “0 ps” and the bandwidth is “16 GHz/first order”.

FIG. 5D illustrates the DGD-electric waveform characteristics when the DGD is “0 ps” and the bandwidth is “16 GHz/third order”. FIG. 5E illustrates the DGD-electric waveform characteristics when the DGD is “0 ps” and the bandwidth is “18 GHz/first order”. FIG. 5F illustrates the DGD-electric waveform characteristics when the DGD is “0 ps” and the bandwidth is “18 GHz/third order”.

FIG. 5G illustrates the DGD-electric waveform characteristics when the DGD is “20 ps” and the bandwidth is “14 GHz/first order”. FIG. 5H illustrates the DGD-electric waveform characteristics when the DGD is “20 ps” and the bandwidth is “14 GHz/third order”. FIG. 5I illustrates the DGD-electric waveform characteristics when the DGD is “20 ps” and the bandwidth is “16 GHz/first order”. FIG. 5J illustrates the DGD-electric waveform characteristics when the DGD is “20 ps” and the bandwidth is “16 GHz/third order”. FIG. 5K illustrates the DGD-electric waveform characteristics when the DGD is “20 ps” and the bandwidth is “18 GHz/first order”. FIG. 5L illustrates the DGD-electric waveform characteristics when the DGD is “20 ps” and the bandwidth is “18 GHz/third order”.

FIG. 5M illustrates the DGD-electric waveform characteristics when the DGD is “30 ps” and the bandwidth is “14 GHz/first order”. FIG. 5N illustrates the DGD-electric waveform characteristics when the DGD is “30 ps” and the bandwidth is “14 GHz/third order”. FIG. 5O illustrates the DGD-electric waveform characteristics when the DGD is “30 ps” and the bandwidth is “16 GHz/first order”. FIG. 5P illustrates the DGD-electric waveform characteristics when the DGD is “30 ps” and the bandwidth is “16 GHz/third order”. FIG. 5Q illustrates the DGD-electric waveform characteristics when the DGD is “30 ps” and the bandwidth is “18 GHz/first order”. FIG. 5R illustrates the DGD-electric waveform characteristics when the DGD is “30 ps” and the bandwidth is “18 GHz/third order”.

For example, as illustrated in FIGS. 4A to 4F or FIGS. 5A to 5F, when the bandwidth is increased by amplification by the electric signal amplifier 105a or 105b, a signal component increases and excellent characteristics may be obtained. For example, for the case where the DGD is “0 ps”, the first-order Gaussian filter characteristics with an increased bandwidth may be optimal. For example, in the relationships illustrated in FIGS. 4A to 4F or FIGS. 5A to 5F, in which the DGD is “0 ps”, for example, the characteristics in the relationship illustrated in FIG. 4A or 5A may be better. In the relationships illustrated in FIGS. 4G to 4L or FIGS. 5G to 5L, in which the DGD is “20 ps”, the characteristics in the relationship illustrated in FIG. 4G or 5G may be better.

For example, as illustrated in FIGS. 4M to 4R or FIGS. 5M to 5R, when the bandwidth is increased by amplification by the electric signal amplifier 105a or 105b, harmonic content may occur. For example, for the case where the DGD is “30 ps”, the third-order Gaussian filter characteristics with a restricted bandwidth may be optimal. For example, as illustrated in FIG. 4Q, in the case where the DGD is “30 ps” and the bandwidth is “18 GHz/first order”, noise serving as harmonic content of an amplified electric signal appears, as indicated by a circle in FIG. 4Q. Due to the harmonic content, the signal characteristics may be deteriorated. For example, as illustrated in FIG. 4R, in the case where the DGD is “30 ps” and the bandwidth is “18 GHz/third order”, noise serving as harmonic content may be cut off and a signal component with less noise may be detected. Similar phenomena may be found in the case of FIGS. 4M and 4N or FIGS. 4O and 4P. In the relationships illustrated in FIGS. 4M to 4R or FIGS. 5M to 5R, in which the DGD is “30 ps”, the characteristics in the relationship illustrated in FIG. 4R or 5R may be better.

In the relationship between the DGD value and the Q value illustrated in FIG. 6, the bandwidth attaining the largest Q value when the DGD is “0 ps” may be “14 GHz/first order”. The bandwidth attaining the largest Q value when the DGD is “20 ps” may be “14 GHz/first order”. The bandwidth attaining the largest Q value when the DGD is “30 ps” may be “18 GHz/third order”. As illustrated in FIG. 6, the bandwidth “14 GHz/first order” exhibits excellent characteristics when the DGD is “0 ps” or “20 ps” and exhibits deteriorated characteristics when the DGD is “30 ps”. When the DGD is “30 ps”, the “18 GHz/third order” characteristics in which the bandwidth has a large steep slope may be better.

Based on the relationship between the DGD and the bandwidth, the storing circuit 101 may store the monitored value of an input light signal and a control value for the bandwidth of the LPF 106a or 106b corresponding to the monitored value.

For example, the optical separator 102 illustrated in FIG. 2 spectrally separates a phase-modulated input light signal that is input at a rate of 40 Gbps, and outputs the separated input light signals to individual circuits provided in the delay interferometer circuit 103 and to the monitor circuit 108. The optical separator 102 may be a coupler. The phase may be modulated in the DQPSK modulation method.

The individual circuits provided in the delay interferometer circuit 103 each detect an input light signal at a rate corresponding to 20 Gpbs. The delay interferometer circuit 103 may be a delay interferometer, for example, a Mach-Zehnder interferometer. For example, in an upper branched circuit, a delay time corresponding to 1 bit is assigned to the input light signal. In a lower branched circuit, the input light signal is phase-shifted by it/4. The delay interferometer circuit 103 allows interference between the input light signal to which a delay time is assigned and the input light signal that is phase-shifted, so that demodulation of the input light signals is performed.

For example, the receiving PD circuit 104 converts the input light signals, which have been demodulated by the delay interferometer circuit 103, into electric signals. The receiving PD circuit 104 may be a photodiode. For example, the electric signal amplifiers 105a and 105b amplify the electric signals converted by the receiving PD circuit 104. The electric signals may be output from the individual electric signal amplifiers 105a and 105b, for example, at a rate of 20 Gbps or more.

For example, the LPF 106a or 106b adjusts the bandwidth of the electric signal amplified by the electric signal amplifier 105a or 105b. The LPF 106a or 106b may be, for example, a variable filter or a filter including a plurality of combined filters. A control value for adjusting the bandwidth is, for example, input from the control circuit 109. The LPFs 106a and 106b adjust the bandwidth of the amplified electric signals based on the control value input from the control circuit 109.

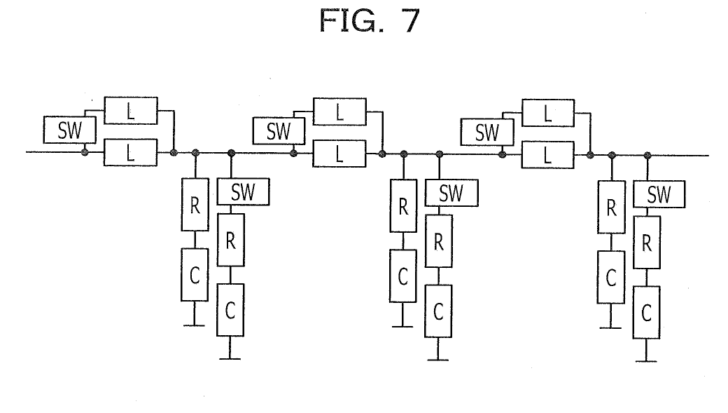

FIG. 7 illustrates an exemplary filter. The filter illustrated in FIG. 7 may be the LPF 106a illustrated in FIG. 2. The structure of the LPF 106b illustrated in FIG. 2 may be substantially the same as or similar to the structure of the LPF 106a illustrated in FIG. 2. In FIG. 7, the sign “SW” represents a switch, the sign “R” represents a resistor, and the sign “C” represents a capacitor. For example, the LPF 106a combines circuits in accordance with switching operations of switches to add or delete an L component, a C component, and an R component, and controls the bandwidth and the filter slope characteristics, for example, a Gaussian order. The Gaussian order may be set to first order or third order.

The framer circuit 107 includes an FEC circuit 107a. For example, the framer circuit 107 acquires frame synchronization based on the electric signals whose bandwidth has been adjusted by the LPFs 106a and 106b, and performs a certain process on the electric signals in units of frames. For example, the FEC circuit 107a detects and corrects a data error in a frame of an electric signal at a rate of 20 Gbps or more, whose the bandwidth has been adjusted, and outputs the processed electric signal at a rate of 40 Gbps. For example, the FEC circuit 107a outputs error count information, which indicates the correction amount of data error, to the control circuit 109 at a desired timing after feed forward (FF) control or the like or in accordance with a request from the control circuit 109. The framer circuit 107 may correspond to a central processing unit (CPU), part of the CPU, a program executed by the CPU, or a field programmable gate array (FPGA).

For example, the monitor circuit 108 monitors the input light signal spectrally separated by the optical separator 102, and outputs a monitored value corresponding to the state of the detected input light signal to the control circuit 109. Detection of the state of the input light signal by the monitor circuit 108 may include monitoring detection of DGD, wavelength dispersion, or the like. For example, the monitor circuit 108 may be a polarization mode dispersion (PMD) measurement device or a degree of polarization (DOP) measurement device. Since a DOP value is correlated with a DGD value, the DGD value may be calculated using a correlation equation based on the DOP value measured by the DOP measurement device. For example, a measurement device or a measurement method disclosed in Nobuhiko Kikuchi, “Analysis of Signal Degree of Polarization Degradation Used as Control Signal for Optical Polarization Mode Dispersion Compensation”, J. Lightwave. Technol., Vol. 19, No. 4, April 2001 or the like may be used.

For example, the control circuit 109 acquires from the storing circuit 101 a control value for the bandwidth of the LPFs 106a and 106b corresponding to the monitored value of the input light signal monitored by the monitor circuit 108. The bandwidth of each of the LPFs 106a and 106b is controlled based on the acquired control value. For example, when the DGD value serving as a monitored value is “0 ps”, the control circuit 109 acquires a control value “14 GHz/first order” from the storing circuit 101, and outputs the control value to the LPFs 106a and 106b. The control circuit 109 may correspond to the CPU, part of the CPU, a program executed by the CPU, or the FPGA.

For example, the control circuit 109 acquires error count information from the FEC circuit 107a, and controls the bandwidth of the LPFs 106a and 106b based on the error count information. For example, the control circuit 109 dynamically optimizes the bandwidth under the feed forward (FF) control via the monitor circuit 108, and finely adjusts the bandwidth under the feed back (FB) control via the FEC circuit 107a.

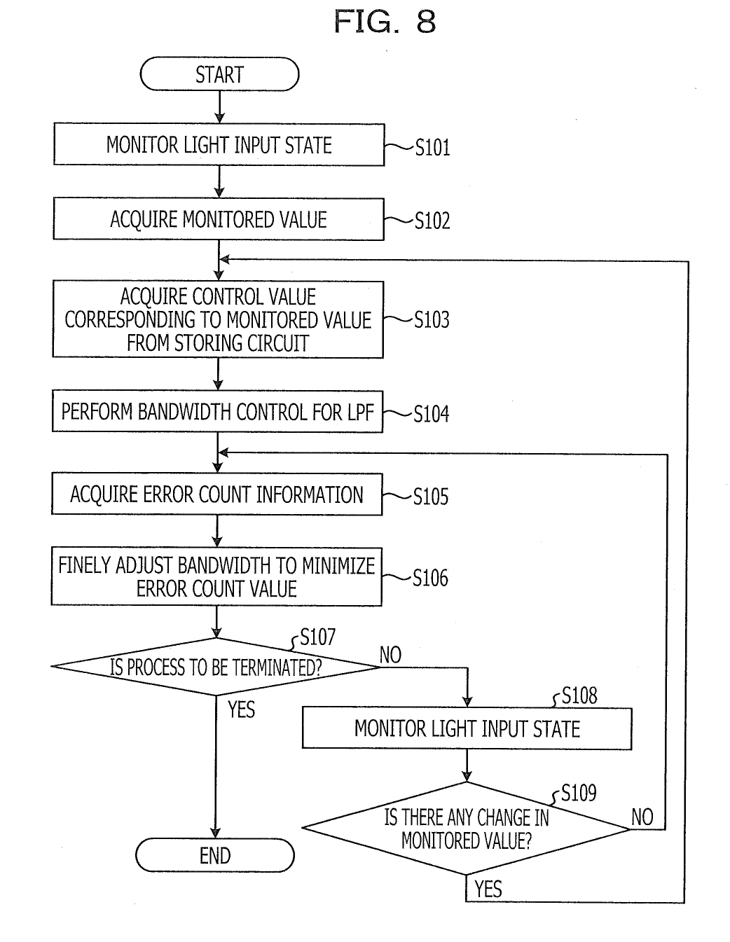

FIG. 8 illustrates an exemplary bandwidth control process.

In an operation S101, for example, the monitor circuit 108 illustrated in FIG. 2 may monitor the light input state of an input light signal. Monitoring of the light input state may include, for example, monitoring detection of DGD, wavelength dispersion, or the like. In the case of monitoring detection of the DGD, the monitor circuit 108 detects the DGD value “0 ps” as a monitored value.

In an operation S102, for example, the control circuit 109 illustrated in FIG. 2 acquires the monitored value from the monitor circuit 108. In an operation S103, the monitor circuit 108 acquires a control value corresponding to the monitored value from the storing circuit 101. In an operation 5104, the control circuit 109 controls the bandwidth of the LPFs 106a and 106b based on the control value. For example, the control circuit 109 acquires the DGD value “0 ps” from the monitor circuit 108, acquires the control value “14 GHz/first order” corresponding to the DGD value from the storing circuit 101, and outputs the control value to the LPFs 106a and 106b. The LPFs 106a and 106b control the bandwidth of amplified electric signals and filter slope characteristics based on the control value, and output the processed electric signals to the framer circuit 107.

In an operation S105, the control circuit 109 acquires error count information from the FEC circuit 107a. In an operation S106, the control circuit 109 finely adjusts the bandwidth of each of the LPFs 106a and 106b to minimize the error count value.

When it is determined that the process is to be terminated (affirmative in an operation S107), the light receiving circuit 100 terminates the execution of the bandwidth control process. When it is determined that the process is not to be terminated (negative in the operation S107), the monitor circuit 108 monitors the light input state again in an operation S108. After acquiring the monitored value, the control circuit 109 checks if there is any change in the monitored value in an operation S109. If there is any change in the monitored value (affirmative in the operation S109), the control circuit 109 performs the operation S103 to dynamically optimize the bandwidth. If there is no change in the monitored value (negative in the operation S109), the control circuit 109 performs the operation S105 to finely adjust the bandwidth.

The light receiving circuit 100 controls the bandwidth of an LPF, which adjusts the bandwidth of an electric signal that has been converted from an input light signal and amplified, based on a control value for the LPF corresponding to a monitored value of the input light signal acquired from a storing circuit. With the use of the light receiving circuit 100, the characteristics of an electric signal with respect to input light may be improved.

The light receiving circuit 100 performs control for the bandwidth of an LPF using the monitored value of an input light signal and control for the bandwidth of the LPF using error count information acquired from the FEC decoder. The characteristics of an electric signal with respect to input light may be improved. When a high-gain amplifier amplifies an electric signal, the light receiving circuit 100 utilizes a control value optimal for controlling the bandwidth of an LPF, which corresponds to a monitored value. Thus, stable characteristics of an electric signal may be obtained, irrespective of the state of an input light signal or the type of a component such as an amplifier.

The gain of an electric signal amplifier may be controlled.

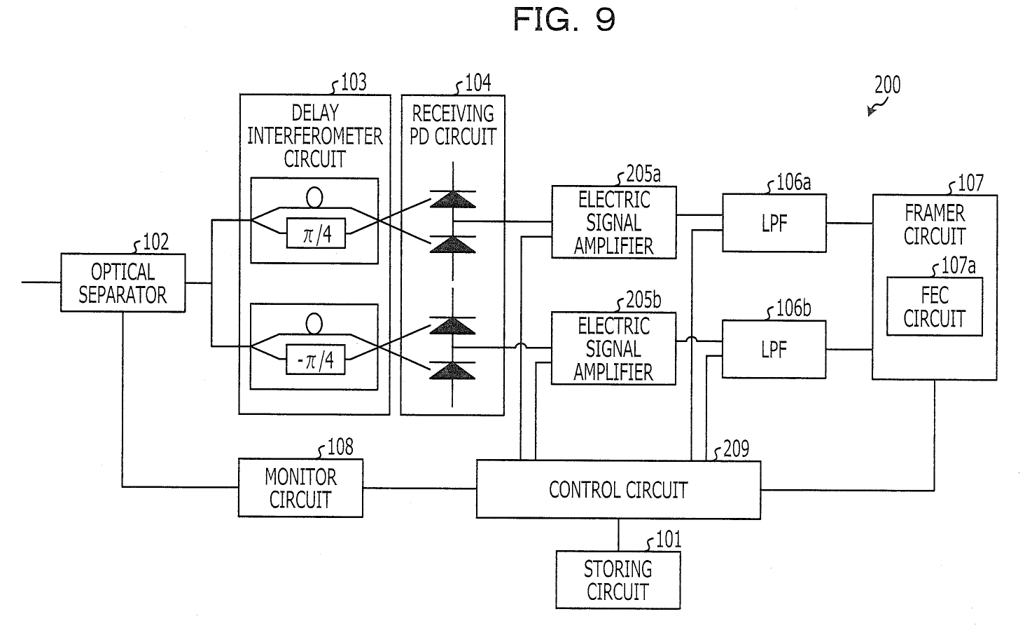

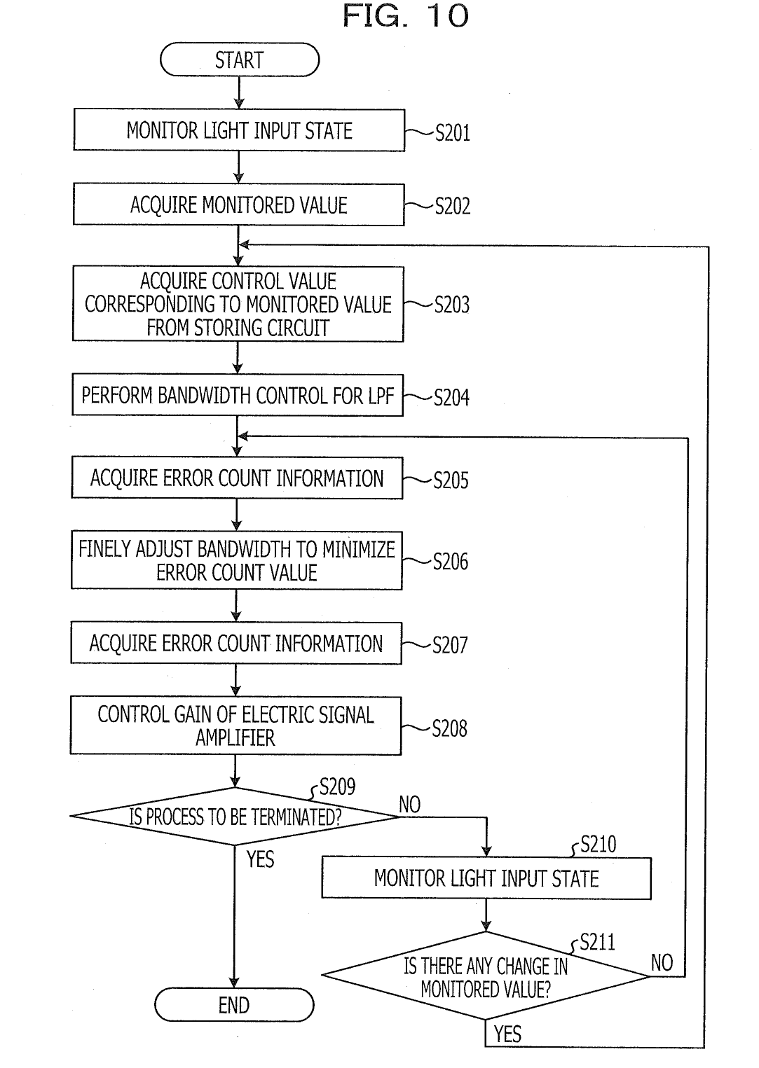

FIG. 9 illustrates an exemplary light receiving circuit. The light receiving circuit illustrated in FIG. 9 may adopt the DQPSK modulation method.

In FIG. 9, elements substantially the same as or similar to the elements illustrated in FIG. 2 may be referred to with the same reference numerals and the explanations of those elements may be omitted or reduced.

A light receiving circuit 200 includes the storing circuit 101, the optical separator 102, the delay interferometer circuit 103, the receiving PD circuit 104, an electric signal amplifier 205a, and an electric signal amplifier 205b. The light receiving circuit 200 also includes the LPF 106a, the LPF 106b, the framer circuit 107, the monitor circuit 108, and the control circuit 209.

For example, the electric signal amplifiers 205a and 205b amplify electric signals converted by the receiving PD circuit 104 based on a gain control value acquired from the control circuit 209. For example, the control circuit 209 acquires error count information from the FEC circuit 107a, and controls the gain of each of the electric signal amplifiers 205a and 205b based on the acquired error count information. For example, the control circuit 209 may control the gain of each of the electric signal amplifiers 205a and 205b to minimize the error count value.

The gain control for the electric signal amplifiers 205a and 205b may be performed by the control circuit 209 after control for the bandwidth of each of the LPFs 106a and 106b is completed.

FIG. 10 illustrates an exemplary bandwidth control process.

For example, the monitor circuit 108 illustrated in FIG. 9 monitors the light input state of an input light signal in an operation S201. For example, monitoring of the light input state may include monitoring detection of DGD, wavelength dispersion, or the like. When monitoring detection of the DGD is made, the monitor circuit 108 may detect the DGD value “0 ps” as a monitored value.

In an operation S202, the control circuit 209 acquires the monitored value from the monitor circuit 108. In an operation S203, the control circuit 209 acquires a control value corresponding to the acquired monitored value from the storing circuit 101. In an operation S204, the control circuit 209 controls the bandwidth of each of the LPFs 106a and 106b based on the control value acquired from the storing circuit 101. For example, the control circuit 209 acquires the DGD value “0 ps” from the monitor circuit 108, acquires the control value “14 GHz/first order” corresponding to the DGD value from the storing circuit 101, and outputs the acquired control value to the LPFs 106a and 106b. The LPFs 106a and 106b control the bandwidth of amplified electric signals and filter slope characteristics on the basis of the control value, and output the processed electric signals to the framer circuit 107.

In an operation S205, the control circuit 209 acquires error count information from the FEC circuit 107a. In an operation S206, the control circuit 209 finely adjusts the bandwidth of each of the LPFs 106a and 106b to minimize the acquired error count value. In an operation S207, the control circuit 209 acquires error count information from the FEC circuit 107a. In operation S208, the control circuit 209 controls the gain of each of the electric signal amplifiers 205a and 205b to minimize the error count value.

When it is determined that the process is to be terminated (affirmative in an operation S209), the light receiving circuit 200 terminates the execution of the bandwidth control process. When it is determined that the process is not to be terminated (negative in the operation S209), the monitor circuit 108 monitors the light input state again in an operation S210. After acquiring the monitored value, the control circuit 209 checks if there is any change in the monitored value in an operation 5211. If there is any change in the monitored value (affirmative in an operation S211), the control circuit 209 performs the operation S203 to dynamically optimize the bandwidth. If there is no change in the monitored value (negative in the operation S211), the control circuit 209 performs the operation S205 to finely adjust the bandwidth or the gain.

The control circuit 209 performs gain control for the electric signal amplifiers 205a and 205b and bandwidth control for the LPFs 106a and 106b, independently of each other. In the operation S205, the control circuit 209 acquires error count information from the FEC circuit 107a. In the operation S206, the control circuit 209 finely adjusts the bandwidth of each of the LPFs 106a and 106b to minimize the error count value. In the operation S205, the control circuit 209 acquires error count information from the FEC circuit 107a. In the operation 5202, the control circuit 209 acquires the monitored value from the monitor circuit 108. In the operation S203, the control circuit 209 acquires the control value corresponding to the monitored value from the storing circuit 101. In the operation S204, the control circuit 209 controls the bandwidth of each of the LPFs 106a and 106b based on the control value acquired from the storing circuit 101. In the operation S202, the control circuit 209 acquires the monitored value from the monitor circuit 108.

When the control circuit 209 performs gain control for the electric signal amplifiers 205a and 205b and bandwidth control for the LPFs 106a and 106b, independently of each other, the cycle of the bandwidth control for the LPFs 106a and 106b and the cycle of the gain control for the electric signal amplifiers 205a and 205b may be different from each other. The control may become stable by the execution in different cycles. For example, the control circuit 209 may perform the gain control in a cycle shorter than the cycle of the bandwidth control.

Since the light receiving circuit 200 performs gain control for amplifiers based on error count information acquired from an FED decoder as well as bandwidth control for LPFs, the characteristics of an electric signal with respect to input light may be improved. In the light receiving circuit 200, after the bandwidth is dynamically optimized under the FF control for the LPFs, the bandwidth or gain is finely adjusted under the FB control for the LPFs and under the FB control for the amplifiers. Thus, the electric signal characteristics may be improved. In the light receiving circuit 200, control for the LPFs and control for the amplifiers are performed in an independent manner. The control for the amplifiers may be performed in a cycle shorter than the cycle of the control for the LPFs. When the control for the LPFs is performed, control for the amplifiers may sufficiently follow the control for the LPFs. In the control for the LPFs, when an operation, which does not induce a characteristic change greater than a specific threshold is prepared, even if a change in an input light signal or an environmental change occurs during the operation, stable characteristics may be obtained.

Bandwidth control may be performed for an input light signal for which phase modulation has been performed in the DPSK modulation method.

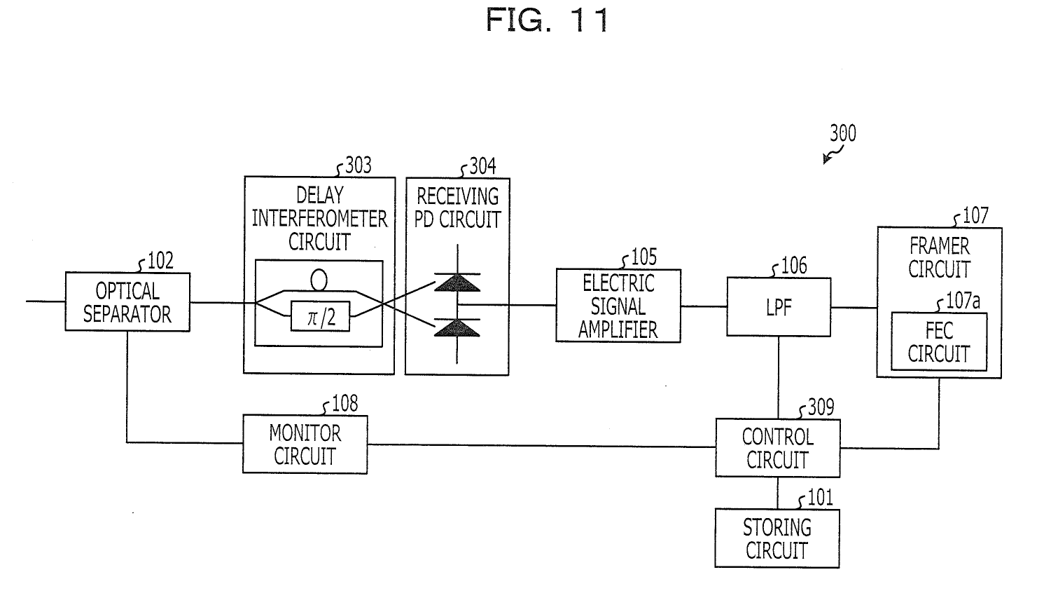

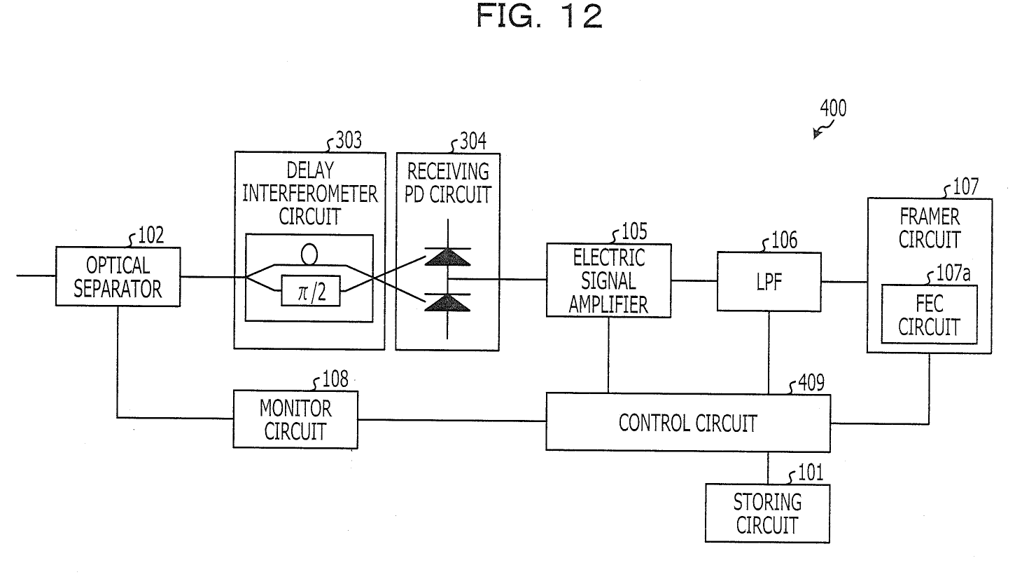

FIG. 11 illustrates an exemplary light receiving circuit. The light receiving circuit illustrated in FIG. 11 may perform bandwidth control for an LPF in the DPSK modulation method. In FIG. 11, elements substantially the same as or similar to the elements illustrated in FIG. 2 may be referred to with the same reference numerals and the explanations of those elements may be omitted or reduced. An electric signal amplifier 105 illustrated in FIG. 11 may correspond to the electric signal amplifiers 105a and 105b illustrated in FIG. 2. An LPF 106 illustrated in FIG. 11 may correspond to the LPFs 106a and 106b illustrated in FIG. 2.

A light receiving circuit 300 illustrated in FIG. 11 includes the storing circuit 101, the optical separator 102, a delay interferometer circuit 303, a receiving PD circuit 304, and the electric signal amplifier 105. The light receiving circuit 300 also includes the LPF 106, the framer circuit 107, the monitor circuit 108, and a control circuit 309.

For example, the delay interferometer circuit 303 detects input light signals branched by the optical separator 102 as input light signals at a rate corresponding to 40 Gbps, and demodulates the input light signals. For example, the receiving PD circuit 304 converts the input light signals demodulated by the delay interferometer circuit 303 into an electric signal.

For example, the control circuit 309 acquires from the storing circuit 101 a control value for the bandwidth of the LPF 106, which corresponds to the monitored value of the input light signal monitored by the monitor circuit 108, and controls the bandwidth of the LPF 106 based on the acquired control value. For example, the control circuit 309 also acquires error count information from the FEC circuit 107a, and controls the bandwidth of the LPF 106 based on the acquired error count information.

FIG. 12 illustrates an exemplary light receiving circuit. The light receiving circuit illustrated in FIG. 12 may perform bandwidth control for an LPF in the DPSK modulation method. In FIG. 12, elements substantially the same as or similar to the elements illustrated in FIG. 2 may be referred to with the same reference numerals and the explanations of those elements may be omitted or reduced. The electric signal amplifier 105 illustrated in FIG. 12 may correspond to the electric signal amplifiers 105a and 105b illustrated in FIG. 2. The LPF 106 illustrated in FIG. 12 may correspond to the LPFs 106a and 106b illustrated in FIG. 2.

A light receiving circuit 400 illustrated in FIG. 12 includes the storing circuit 101, the optical separator 102, the delay interferometer circuit 303, the receiving PD circuit 304, and the electric signal amplifier 105. The light receiving circuit 400 also includes the LPF 106, the framer circuit 107, the monitor circuit 108, and a control circuit 409.

For example, the control circuit 409 acquires error count information from the FEC circuit 107a, and controls the gain of the electric signal amplifier 105 based on the acquired error count information. For example, the control circuit 409 controls the gain of the electric signal amplifier 105 to minimize the error count value.

For example, after performing bandwidth control for the LPF 106, the control circuit 409 performs gain control for the electric signal amplifier 105. For example, the control circuit 409 performs the gain control for the electric signal amplifier 105 and the bandwidth control for the LPF 106 in an independent manner. The control circuit 409 may perform the gain control for the electric signal amplifier 105 in a cycle shorter than the cycle of the bandwidth control for the LPF 106.

The FF control based on the monitored value acquired from the monitor circuit 108 and the FB control based on the error count information acquired from the FEC circuit 107a are performed. The light receiving circuit 100 may perform only the FF control. The characteristics of an electric signal with respect to input light may be improved.

FEC is adopted as error detection. Code that enables error detection or error correction may be adopted as error detection.

A DGD value is used as detection of the state of an input light signal. Monitoring detection of wavelength dispersion or the like may be used as detection of the state of an input light signal. For wavelength dispersion, a monitored value corresponding to wavelength dispersion may be stored in the storing circuit 101.

The process procedures, control procedures, specific names, data, or information including parameters etc. (for example, information stored in the storing circuit 101) may be changed in a desired manner. For example, information stored in the storing circuit 101 may be different depending on the result of monitoring detection of the state of an input light signal.

Elements such as the light receiving circuit 100 may be functional elements or physical elements. The configuration of a device may be functionally or physically distributed or integrated in desired units in accordance with the load or use conditions. For example, the control circuit 209 of the light receiving circuit 200 may be distributed into a “bandwidth control circuit” for controlling the bandwidth of an LPF and a “gain control circuit” for controlling the gain of an electric signal amplifier.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A light receiving circuit comprising:
a filter, arranged in a downstream of an electric signal amplifier to amplify an electric signal based on a light signal, to adjust a bandwidth of an amplified electric signal;
a monitor circuit to monitor a communication quality of the light signal and output a monitored value; and
a control circuit to control a bandwidth of the filter based on a control value corresponding to the monitored value.

2. The light receiving circuit according to claim 1, wherein the control value is acquired from a storing circuit to store the control value corresponding to the monitored value.

3. The light receiving circuit according to claim 1, wherein the control circuit controls a gain of the electric signal amplifier after performing the control for the filter.

4. The light receiving circuit according to claim 1, further comprising,
an error detection circuit, arranged in a downstream of the filter, to supply error information to the control circuit.

5. The light receiving circuit according to claim 4, wherein the control circuit controls the bandwidth of the filter based on the error information.

6. The light receiving circuit according to claim 4, wherein the control circuit controls the gain of the electric signal amplifier based on the error information.

7. The light receiving circuit according to claim 1,
wherein the control circuit performs the control for the bandwidth of the filter and the control for the gain of the electric signal amplifier in an independent manner, and
wherein the cycle of the control for the bandwidth of the filter is different from the cycle of the control for the gain of the electric signal amplifier.

8. A bandwidth control method, comprising:
monitoring a communication quality of a light signal and outputting a monitored value;
amplifying an electric signal which is converted from the light signal and corresponds to the monitored value;
acquiring a control value for adjusting the bandwidth of an amplified electric signal based on the monitored value; and
controlling the bandwidth of the electric signal based on the control value.

9. The bandwidth control method according to claim 8, further comprising,
acquiring the control value from a storing circuit to store the control value which corresponds to the monitored value.

10. The bandwidth control method according to claim 8, further comprising,
controlling the bandwidth of a filter to adjust the bandwidth of the electric signal based on the control value.

11. The bandwidth control method according to claim 8, further comprising:
detecting an error from the electric signal with a controlled bandwidth to output a detected error as error information; and
controlling the bandwidth of the electric signal based on the error information.

12. The bandwidth control method according to claim 8, further comprising:
detecting an error from the electric signal with a controlled bandwidth to output a detected error as error information; and
controlling the gain for amplifying the electric signal based on the error information.

13. The bandwidth control method according to claim 8, further comprising;
controlling the bandwidth of the electric signal in a first cycle; and
controlling the gain for amplifying the electric signal in a second cycle which is different from the first cycle.

14. The bandwidth control method according to claim 13, wherein the first cycle is longer than the second cycle.
